(19) United States
(12) Patent Application Publication
(10) Pub. No.: US 2001/0020257 A1
(43) Pub. Date: Sep. 6, 2001

(54) Method and an integrated circuit for controlling access of at least two masters to a common bus

(76) Inventors: Olivier Berthaud, Paris (FR); Gilles Eyzat, La Garenne Colombes (FR)

Correspondence Address: SUGHRUE, MION, ZINN, MACPEAK & SEAS, PLLC, Suite 800, 2100 Pennsylvania Avenue, N.W., WASHINGTON, DC, 20037-3213, US

(21) Appl. No.: 09/796,654

(22) Filed: Mar. 2, 2001

(30) Foreign Application Priority Data
Mar. 6, 2000 (FR) 00 02 820

(51) Int. Cl. G06F 13/36

(52) U.S. Cl. 710/117; 710/110

(57) ABSTRACT

In this method, access to the bus is controlled by a policy assigning graded priorities to the various masters so that a new priority master succeeds a current master on the bus as soon as that current master leaves the bus. The priority assignment policy is implemented by logic gates integrated into a circuit, for example an application-specific integrated circuit. Each master is assigned a time slot for occupying the bus, said slot constituting a modifiable parameter specific to the master to which it is assigned. The priority assignment policy is preferably a last recently used policy whereby the highest priority level is assigned to the least recently used master.

The present invention relates to a method and an integrated circuit for controlling access of at least two masters to a common bus.

### BACKGROUND OF THE INVENTION

It applies in particular to controlling access to a common bus of a plurality of microprocessors used in mobile or fixed telephone equipment units, where applicable integrated into a multimedia environment providing access to the Internet in particular.

For example, an architecture combining a plurality of masters intended to access a common bus can include a central processor which is dedicated to general tasks, a digital signal processor (DSP) which is dedicated to particular mathematical processes and a direct memory access (DMA) module.

In one type of method and integrated circuit for controlling access of at least two masters to a common bus known in the art access to the bus is controlled by a policy assigning graded priorities to the masters so that a new priority master succeeds a current master on the bus as soon as that current master leaves the bus, the priority assignment policy being implemented by logic gates integrated into the circuit.

Several types of policy for controlling the relative priorities of different masters are also known in the prior art. There are “fixed” policies, for example, whereby graded priorities are assigned once and for all to the masters, the highest level priority being assigned permanently to the same master. There are also “circular” policies whereby graded priorities assigned to the masters are modified by circular permutation. There are also “last recently used” (LRU) policies whereby the highest level priority is assigned to the “least recently used” master, i.e. the master who least recently occupied the bus. There are priority management policies other than those referred to by way of example above, of course, some of which can be of the pseudo-random kind.

The logic gates implementing a priority management policy are integrated into an application-specific integrated circuit (ASIC). To satisfy ever-increasing numbers of new applications subject to severe real-time operating constraints, chip set manufacturers are keen to improve the performance of architectures including multiple microprocessors. This leads to complementing master-slave architectures with multimaster architectures enabling parallel operation of the master microprocessors, or at least giving the user the impression of parallel operation of those masters.

However, in the case of a multimaster architecture, managing priority of access to a common bus by means of arbitration policies like those referred to above by way of example is not enough to guarantee sufficient bandwidth for each master (the number of cycles per unit time during which a master occupies the bus).

Depending on the functions of the master processors and the chosen priority assignment policy, there is a risk of a master monopolizing the bus by constantly sending messages over the bus or of a master never having a request for access for the bus satisfied.

### OBJECTS AND SUMMARY OF THE INVENTION

An object of the invention is to control access of a plurality of master processors to a common bus by means of a priority assignment policy implemented by an ASIC which guarantees each master access to the common bus and limits the waiting time between a master submitting a request for access to the bus and that request being acknowledged.

To this end, the invention provides a method of the type referred to above of controlling access of at least two masters to a common bus, wherein each master is assigned a time slot for occupying the bus, said slot constituting a modifiable parameter specific to the master to which it is assigned.

According to other features of the method:

the priority assignment policy is a last recently used (LRU) policy whereby the highest priority level is assigned to the least recently used master; and

the time slots for occupying the bus are modified by software.

The invention also provides an integrated circuit of the type referred to above for controlling access of at least two masters to a common bus, the integrated circuit including data storage means containing time slots for occupation of the bus assigned to the respective masters.

According to other features of the integrated circuit:

the storage means take the form of a randomaccess memory and/or registers to enable modification of the time slots by software; and

the circuit constitutes an application-specific integrated circuit (ASIC).

### BRIEF DESCRIPTION OF THE DRAWINGS

The invention will be better understood after reading the following description, which is given by way of example only and with reference to the accompanying drawings, in which:

FIG. 1 is a diagrammatic view of an application-specific integrated circuit module according to the invention;

FIG. 2 is a diagram showing one example of a sequence of occupation of a bus by three masters;

FIG. 3 is a diagram similar to that of FIG. 2 showing the evolution of the bus occupation sequences when one of the three masters no longer requires the bus; and

FIGS. 4 to 6 are diagrams showing examples of managing priorities for access of four masters to a common bus in accordance with a last recently used (LRU) policy.

### MORE DETAILED DESCRIPTION

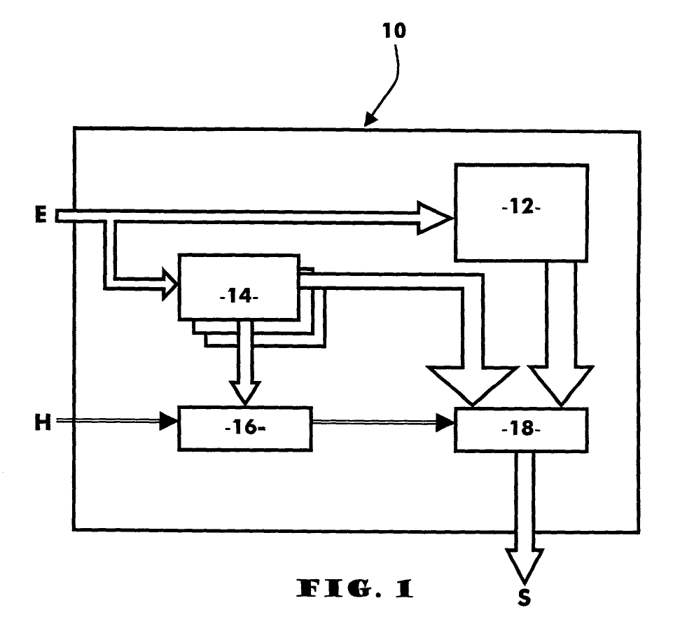

FIG. 1 shows an integrated circuit module 10 in accordance with the invention. The circuit is an application-specific integrated circuit (ASIC).

The integrated circuit module 10 is for controlling access of a plurality of master microprocessors (at least two masters) to a conventional common bus, not shown, to enable parallel operation of the master processors or at least to give the user the impression that those masters are operating in parallel.

To this end, the integrated circuit module 10 receives requests from the masters for access to the bus at its input E and supplies request acknowledgments at its output S.

The integrated circuit module 10 further includes a unit 12 for managing the priorities of the various masters, implemented in a manner that is known in the prior art by logic gates integrated into the module, and means 14 for storing data defining bus occupation time slots assigned to respective masters. The data is preferably stored in a table.

The unit 12 conventionally assigns graded priorities to the masters so that a new priority master succeeds a current master on the bus as soon as that current master leaves the bus.

The unit 12 preferably employs a standard last recently used (LRU) priority assignment policy whereby the highest level priority is assigned to the “least recently used” master.

The storage means 14 preferably takes the form of a random/access memory (RAM) and/or registers so that the values of the time slots contained in the tables can be modified. Each slot therefore constitutes a modifiable parameter specific to the master to which it is assigned. The time slots are programmed by software in a manner that is known in the prior art.

The integrated circuit module 10 further includes a counter generator and an acknowledgment generator 18.

The counter generator 16, which is clocked by a clock H, informs the acknowledgment generator 18 of the expiry of a stored time slot.

The acknowledgment generator 18 generates an acknowledgment in accordance with information supplied by the priority control unit 12, the storage means 14 and the counter generator 16.

FIG. 2 is a diagram showing one example of the sequence of occupation of a bus by three masters M1 to M3. The pass-bands of each of the masters M1 to M3 on the bus are represented separately by crenellated curves having either the value 0 when the master is absent from the bus or the value 1 when the master is occupying the bus. A time slot T1 to T3 for occupying the bus is assigned to each master M1 to M3.

FIG. 2 shows that, in accordance with the priority control policy, a new priority master succeeds a current master on the bus as soon as that current master leaves the bus (synchronous replacement). Accordingly, in this example, the second master M2 succeeds the first master M1, the third master M3 succeeds the second master M2, and the first master M1 succeeds the third master M3.

FIG. 2 also shows that no master can monopolize the bus beyond their time slot.

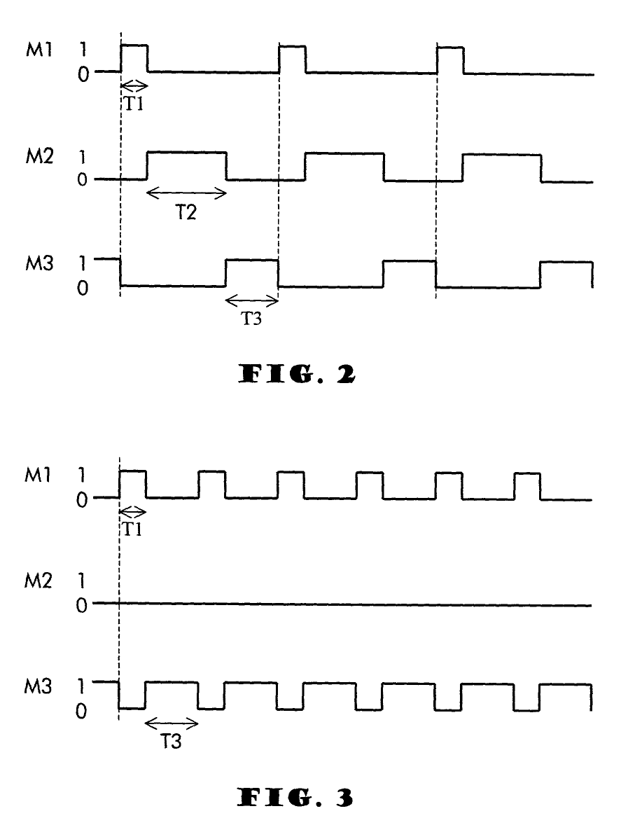

FIG. 3 shows the situation in which the second master M2 ceases to require the bus. In accordance with the priority management policy, the third master M3 succeeds the first master M1 and the first master M1 succeeds the third master M3 in this case. The time slots of the two masters M1,M3 requiring the bus are not modified by the withdrawal of the request from the other master M2. However, the pass-band of each master M1,M3 requiring the bus is increased compared to the situation illustrated in FIG. 2 because the frequency of occupation of the bus is increased for each of them.

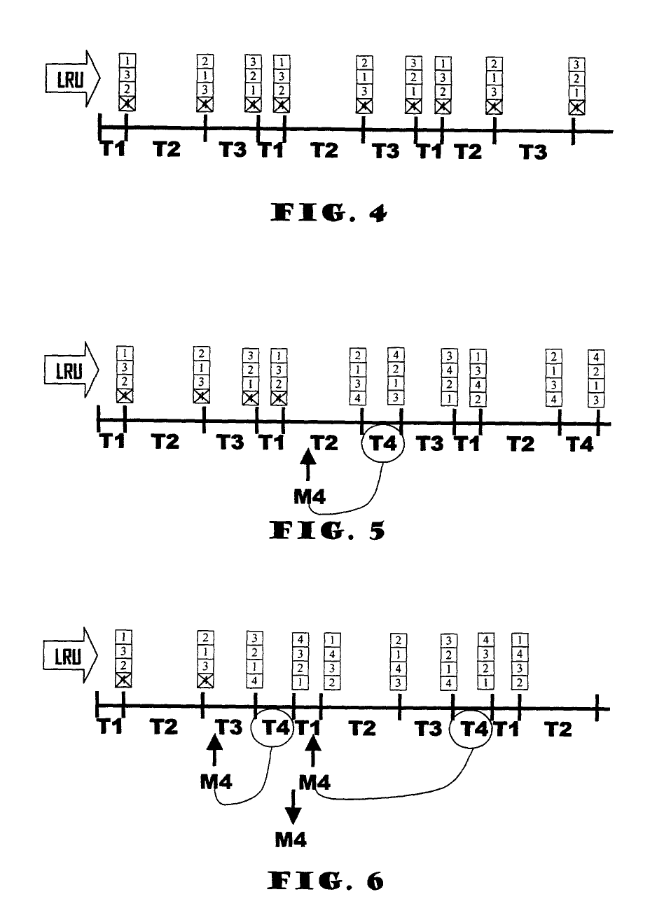

The FIG. 4 diagram shows one example of managing priorities for access of four masters M1 to M4 to a common bus in accordance with a last recently used (LRU) policy.

The succession of masters on the bus is symbolized by a succession of segments on the horizontal axis, each segment corresponding to a time slot T1 to T4 allocated to a master M1 to M4. FIG. 4 shows that the fourth master M4 does not require the bus.

Controlling the gradation of the priorities of the masters in accordance with the LRU policy is symbolized by successive columns in which the numbers 1 to 4 identify the respective four masters. The lower down the column a number appears, the higher the priority level of the corresponding master. The number of the fourth master M4, who does not require the bus, is crossed out. Each column therefore indicates the priority master for access to the bus on expiry of the time slot of the current master occupying the bus.

The FIG. 5 and FIG. 6 diagrams show the processing of a request from the fourth master M4 for access to the bus.

In a first situation, shown in FIG. 5, the period of the request from the fourth master M4 is greater than the sum of the time slots of the three other masters.

In accordance with the LRU priority assignment policy, the highest priority level is assigned to the master M4 entering an access request because this master is the “least recently used” master. The access request from the fourth master M4, which appears during the time slot in which the second master M2 occupies the bus, for example, is acknowledged at the end of that time slot. For as long as the fourth master M4 maintains its request, the frequency of the time slots of the fourth master M4 on the bus (and therefore the pass-band of the master M4) is imposed by the LRU logic.

It can therefore be concluded that, in this first situation, the maximum waiting time between a new request by a master and the acknowledgment of that request is equal to the duration of the longest time slot.

In a second situation, shown in FIG. 6, the period of the request from the fourth master M4 is less than the sum of the time slots of the other three masters.

As previously, the highest level of priority is assigned to the master M4 entering an access request, because this master is the “least recently used” master. The request from the fourth master M4, which appears during the time slot in which the third master M3 occupies the bus, for example, is acknowledged at the end of that time slot. The frequency of the time slots of the fourth master M4 on the bus (and therefore the bandwidth of that master M4) is then imposed by the LRU logic.

However, in this case, because the period of the request from the fourth master M4 is less than the sum of the time slots of the other three masters, the fourth master M4 immediately withdraws its first request for access to the bus at the end of the time slot associated with it, for example, and introduces a second request during the time slot in which the first master M1 occupies the bus, immediately succeeding the fourth master M4.

Since the acknowledgment of the first request imposes the frequency of the time slots of the fourth master M4 on the bus, the LRU policy is not modified by the disappearance of the request from the master M4 or its rapid re-appearance (within a period less than the sum of the time slots of the other three masters). Accordingly, the new request from the fourth master M4 is not acknowledged until after the successive time slots of the other three masters have elapsed.

It can therefore be concluded that, in this second situation, the maximum waiting time between a new request by a master and the acknowledgment of that request is equal to the sum of the time slots of all the other masters.

The integrated circuit module 10 is preferably produced from known elements by designing it using a standard hardware description language, for example VHDL.

An algorithm defining the operation of the integrated circuit module 10 according to the invention is set out below by way of example.

The algorithm, drafted synthetically with language elements familiar to the skilled person, will readily enable the skilled person to define the integrated circuit module 10 entirely in VHDL and thereby fabricate the integrated circuit.

Main Sequence

*Replace a current master occupying the bus by its successor on the bus, called the next master, on expiry of the time slot of the current master, and manage the assignment of priority on each replacement of the master in accordance with a LRU policy.*

begin

while true

if counter=master_time_slot(current_master)

next_master←fct_determine_next_master

retire current_master

current_master←next_master

acknowledge current_master

fct_activate LRU

end if

end while

end

Counter Management

*Set the counter to zero on expiry of the time slot of the current master and increment the counter otherwise.*

begin

clock pulse

if counter=master_time_slot(current_master)

counter←0

else

counter++

end if

end

Function: fct_determine_next_master

*Determine the next master succeeding the current master according to the priorities and the activation of requests from masters.*

begin

for each master in LRU_queue

if(max(priority(master)and(request(master)activated)

then next_master←master

end if

end for

end

Function: fct_activate_LRU

*Re-evaluate the priorities of the masters.*

begin

for each master in LRU_queue

if(priority(master)<=priority(current_master))

increase priority

end if

end for

priority(current_master)←minimum_priority

end

The advantages of the invention include in particular the fact that it guarantees access of each of the masters to the common bus and limits the waiting time between the request from a master and its acknowledgment to a time period which, in the case of an LRU policy, can be either the longest of the time slots assigned to the masters or the sum of the time slots of the masters for which requests to access the bus are active.

The time slots associated with the various masters constitute parameters that can be modified dynamically by software.

Of course, the invention is not limited to the embodiment described above. In particular, the skilled person can if necessary choose a priority assignment policy other than an LRU policy.

1. A method of controlling access of at least two masters to a common bus, wherein access to the bus is controlled by a policy assigning graded priorities to the various masters so that a new priority master succeeds a current master on the bus as soon as that current master leaves the bus, said priority assignment policy being implemented by logic gates integrated into a circuit, wherein each master is assigned a time slot for occupying the bus, said slot constituting a modifiable parameter specific to the master to which it is assigned.

2. A method according to claim 1, wherein the priority assignment policy is a last recently used policy whereby the highest priority level is assigned to the least recently used master.

3. A method according to claim 1, wherein the time slots for occupying the bus are modified by software.

4. An integrated circuit for controlling access of at least two masters to a common bus, wherein access to the bus is controlled by a policy assigning graded priorities to the masters so that a new priority master succeeds a current master on the bus as soon as that current master leaves the bus, said priority assignment policy being implemented by logic gates integrated in the circuit, the method including data storage means containing time slots for occupation of the bus assigned to the respective masters.

5. A circuit according to claim 4, wherein the storage means take the form of a random-access memory and/or registers to enable modification of the time slots by software.

6. A circuit according to claim 4, constituting an application-specific integrated circuit.
